(19) United States
(12) Patent Application Publication
(10) Pub. No.: US 2010/0202678 A1
(43) Pub. Date: Aug. 12, 2010

(54) X-RAY DIAGNOSIS APPARATUS AND IMAGE PROCESSING METHOD

(76) Inventor: Masaki KOBAYASHI, Otawara-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/704,992

(22) Filed: Feb. 12, 2010

(30) Foreign Application Priority Data
Feb. 10, 2009 (JP) 2009-028734
Jan. 19, 2010 (JP) 2010-009460

(51) Int. Cl. G06K 9/00; G09G 5/00

(52) U.S. Cl. 382/132; 345/634

(57) ABSTRACT

An X-ray tube generates X-rays. An X-ray detector detects X-rays generated by the X-ray tube and transmitted through a subject. A storage unit stores data of a gullet image associated with a gullet of the subject. An X-ray image generation unit generates data of an X-ray image based on an output from the X-ray detector during catheter operation. The X-ray image is associated with a left atrium located anatomically near the gullet. A display control unit displays a gullet region of the gullet image together with the X-ray image on the display device while superimposing the gullet region on the X-ray image to allow visual recognition of a distal end portion of a catheter region included in the X-ray image.

### CROSS-REFERENCE TO RELATED APPLICATIONS

This application is based upon and claims the benefit of priority from prior Japanese Patent Applications No. 2009-028734, filed Feb. 10, 2009; and No. 2010-009460, filed Jan. 19, 2010, the entire contents of both of which are incorporated herein by reference.

### BACKGROUND OF THE INVENTION

1. Field of the Invention

The present invention relates to an X-ray diagnosis apparatus used for ablation treatment and an image processing method associated with the X-ray diagnosis apparatus.

2. Description of the Related Art

In ablation treatment, the operator grasps the position of an ablation catheter by using an X-ray diagnosis apparatus. In ablation treatment for the left atrium, it is important to grasp the position and shape of the gullet as well as the position of the ablation catheter. This is because, since the gullet is positioned on the back of the left atrium when viewed in the anterior-posterior direction, the heat generated from the ablation catheter may damage the gullet. However, the contrast of the gullet cannot be enhanced by a contrast medium.

There is available a technique of capturing the volume data generated by an X-ray computed tomography apparatus into an X-ray diagnosis apparatus. It is therefore possible to inform the operator of the position and shape of the gullet during ablation treatment by capturing volume data concerning the gullet, which is generated by the X-ray computed tomography apparatus, into the X-ray diagnosis apparatus before an operation.

If, however, volume data is simply captured and displayed, the area of gullet is displayed as a filled-in object. For this reason, the operator cannot see the catheter superimposed on the gullet on the displayed image. Displaying the gullet therefore will decrease the efficiency of ablation treatment.

### BRIEF SUMMARY OF THE INVENTION

It is an object of the present invention to provide an X-ray diagnosis apparatus and image processing method associated with the X-ray diagnosis apparatus which improves the accuracy and efficiency of ablation treatment.

According to a first aspect of the present invention, an X-ray diagnosis apparatus includes: an X-ray tube which generates X-rays; an X-ray detector which detects X-rays generated by the X-ray tube and transmitted through a subject; a storage unit which stores data of a gullet image associated with a gullet of the subject; a generation unit which generates data of an X-ray image based on an output from the X-ray detector during catheter operation, the X-ray image being associated with a left atrium located anatomically near the gullet; and a display unit which displays a gullet region of the gullet image together with the X-ray image while superimposing the gullet region on the X-ray image to allow visual recognition of a distal end portion of a catheter region included in the X-ray image.

According to a second aspect of the present invention, an image processing method associated with an X-ray diagnosis apparatus comprising an X-ray tube which generates X-rays, and an X-ray detector which detects X-rays generated by the X-ray tube and transmitted through a subject, the method including: generating data of an X-ray image based on an output from the X-ray detector during catheter operation, the X-ray image being associated with a left atrium located anatomically near the gullet; and displaying a gullet region of the gullet image together with the X-ray image while superimposing the gullet region on the X-ray image to allow visual recognition of a distal end portion of a catheter region included in the X-ray image.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of an X-ray diagnosis apparatus according to an embodiment of the present invention;

FIG. 2 is a view showing the positional relationship between the heart and the gullet;

FIG. 3 is a view showing an example of how a display control unit in FIG. 1 superimposes and displays only the edges of the gullet region on an X-ray image;

FIG. 4 is a flowchart showing a typical procedure for ablation catheter operation support processing performed under the control of a system control unit in FIG. 1; and

FIG. 5 is a view showing an example of how it is informed in step S7 in FIG. 4 that an ablation catheter approaches the gullet.

### DETAILED DESCRIPTION OF THE INVENTION

An X-ray diagnosis apparatus and an image processing method associated with the X-ray diagnosis apparatus according to an embodiment of the present invention will be described below with reference to the views of the accompanying drawing.

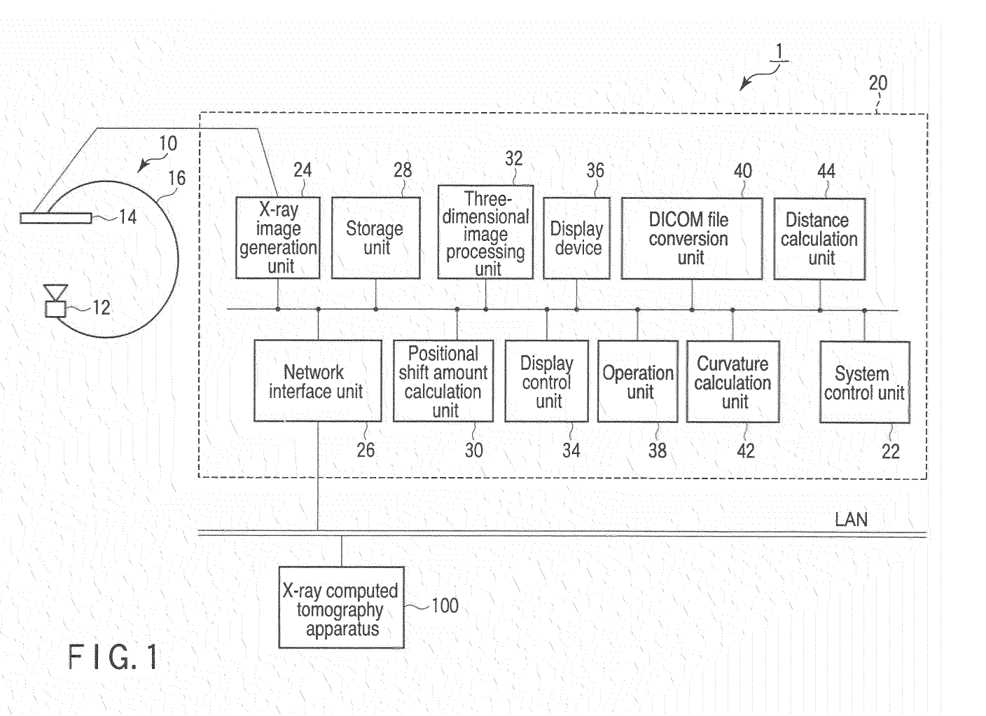

FIG. 1 is a block diagram showing the arrangement of an X-ray diagnosis apparatus 1 according to this embodiment. As shown in FIG. 1, the X-ray diagnosis apparatus 1 is connected to an X-ray computed tomography apparatus 100 via a LAN (Local Area Network). The X-ray diagnosis apparatus 1 and the X-ray computed tomography apparatus 100 constitute an ablation treatment support system.

The X-ray computed tomography apparatus 100 generates volume data concerning a subject before ablation treatment. The X-ray computed tomography apparatus 100 extracts a gullet region and a specific region from the generated volume data. The specific region is used for positioning. The volume data of the gullet region and the volume data of the specific region are converted into a format conforming with the DICOM (Digital Imaging and COmmunications in Medicine) standard. The resultant data is transmitted as patient data to the X-ray diagnosis apparatus 1. Note that the coordinate system of the volume data of the gullet region coincides with the coordinate system of the volume data of the specific region.

The X-ray diagnosis apparatus 1 is used for ablation treatment. The X-ray diagnosis apparatus 1 is mainly used to grasp the position of an ablation catheter or electrode catheter. During ablation treatment, the X-ray diagnosis apparatus 1 performs X-ray fluoroscopy of the chest region of the subject to continuously generate X-ray image data concerning the left atrium of the subject. A generated X-ray image includes an ablation catheter region or an electrode catheter region.

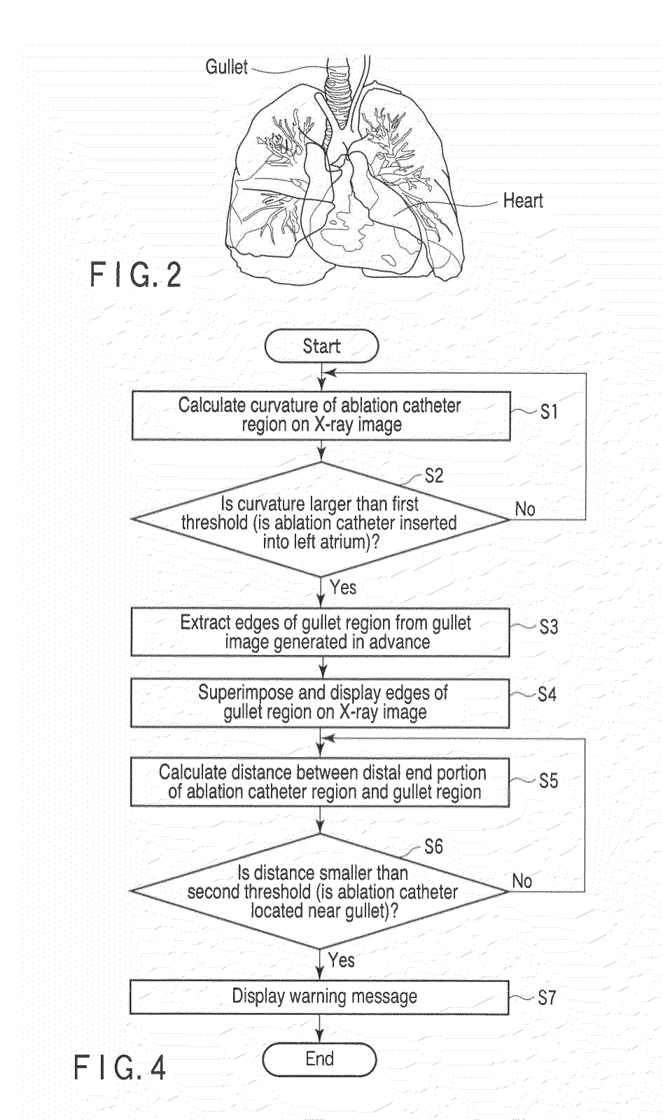

Ablation treatment is a treatment method for a tachyarrhythmia. In ablation treatment, in general, the operator inserts an ablation catheter into a thick blood vessel in the root of the foot or the like and cauterizes a portion which causes an arrhythmia inside the heart with a high-frequency current. This method is called myocardial cauterization. A portion which causes an arrhythmia sometimes appears in part of the left atrium of the heart. As shown in FIG. 2, the gullet is positioned on the back of the left atrium when viewed in the anterior-posterior direction. In cauterization of the left atrium, the heat generated by the ablation catheter may damage the gullet.

When a catheter is superimposed on the gullet on an X-ray image, the X-ray diagnosis apparatus 1 according to this embodiment therefore superimposes and displays an X-ray image and a gullet image in a display form that allows the operator to grasp the positional relationship between the distal end portion of the catheter and the gullet. Note that as described above, the X-ray diagnosis apparatus 1 generates an X-ray image during ablation treatment. The X-ray diagnosis apparatus 1 generates a gullet image based on the volume data of the gullet region supplied from the X-ray computed tomography apparatus 100.

The arrangement of the X-ray diagnosis apparatus 1 will be described below with reference to FIG. 1.

As shown in FIG. 1, the X-ray diagnosis apparatus 1 includes an imaging apparatus 10 and an image processing apparatus 20. The imaging apparatus 10 includes an arm 16 on which an X-ray tube 12 and an X-ray detector 14 are mounted. The X-ray tube 12 generates X-rays upon receiving a high voltage applied from a high voltage generator (not shown). The X-ray detector 14 detects the X-rays generated from the X-ray tube 12 and transmitted through a subject. The X-ray detector 14 includes a flat panel detector (FPD) having a plurality of semiconductor detection elements arranged in a matrix form. The X-ray detector 14 may include a combination of an image intensifier and a TV camera in place of the FPD. The X-ray diagnosis apparatus 1 performs X-ray imaging or X-ray fluoroscopy by controlling the imaging apparatus 10. X-ray fluoroscopy is a method of continuously irradiating a subject with a smaller dose of X-rays than that in X-ray radiography.

The image processing apparatus 20 includes a system control unit 22 as a central unit, an X-ray image generation unit 24, a network interface unit 26, a storage unit 28, a positional shift amount calculation unit 30, a three-dimensional image processing unit 32, a display control unit 34, a display device 36, an operation unit 38, and a DICOM file conversion unit 40.

The X-ray image generation unit 24 generates the data of an X-ray image by converting an electrical signal corresponding to the intensity of transmitted X-rays and output from the X-ray detector 14 into a digital signal and preprocessing the digital signal. The X-ray image includes an ablation catheter region and an electrode catheter region. The ablation catheter region is a pixel region corresponding to the ablation catheter inserted in the left atrium. The electrode catheter region is a pixel region corresponding to the electrode catheter inserted in the left atrium. It does not matter whether the contrast of the left atrium is enhanced or not enhanced. If the contrast is not enhanced, it is impossible to visually recognize the left atrium on the X-ray image. In the case of X-ray fluoroscopy, the data of about 30 to 60 X-ray images are generated per sec.

The network interface unit 26 is connected to the LAN. The X-ray computed tomography apparatus 100 is connected to the LAN. The network interface unit 26 communicates with the X-ray computed tomography apparatus 100 connected to the LAN. The network interface unit 26 reads out patient data from the X-ray computed tomography apparatus 100.

The storage unit 28 stores X-ray image data, patient data, gullet image data, and the like. As described above, the patient data includes the volume data of the gullet region and the volume data of the specific region.

The positional shift amount calculation unit 30 calculates the positional shift amount between the coordinate system in the X-ray diagnosis apparatus 1 and the coordinate system of the volume data of the gullet region. More specifically, the positional shift amount calculation unit 30 calculates the positional shift amount between the specific region and the pixel region on the X-ray image which is anatomically identical to the specific region. The specific region is preferably a pixel region having a high contrast that allows easy positioning, e.g., a pixel region corresponding to the vertebral body in the spine. It is not necessary to calculate positional shift amounts for all generated X-ray images. It is only required to perform this calculation once per imaging angle.

The three-dimensional image processing unit 32 performs projection processing for the volume data of the gullet region at the projection angle based on the calculated positional shift amount generate the data of a gullet image. The gullet image includes a gullet region as a pixel region corresponding to the gullet. There is no positional shift between the generated gullet image and the X-ray image. Note that projection processing includes volume rendering processing, surface rendering processing, and the like as well as pixel value projection processing such as maximum value projection processing, minimum value projection processing, and average value projection processing.

The display control unit 34 displays the gullet image and the X-ray image on the display device 36 by a predetermined display method to allow visual recognition of the distal end portion of the catheter region. The catheter region includes an ablation catheter region, an electrode catheter region, and the like. Specific display methods include a method of displaying the edges of the gullet region included in the gullet image together with the X-ray image while superimposing the edges on the X-ray image, a method of displaying the gullet region together with the X-ray image while superimposing the gullet region on the X-ray image and blinking the gullet region, and a method of displaying the gullet region together with the X-ray image while superimposing the gullet region on the X-ray image and making the gullet region translucent. The display device 36 includes, for example, a CRT (Cathode-Ray Tube). In this manner, the display control unit 34 and the display device 36 constitute a display unit.

The operation unit 38 accepts various commands and information inputs from the operator. As the operation unit 38, a pointing device such as a mouse or a trackball, a selection device such as a mode switch, or an input device such as a keyboard can be used, as needed. More specifically, the operation unit 38 selects one of the above display methods in accordance with an instruction from the operator. That is, the operation unit 38 selects one of the method of displaying the edges of the gullet region included in the gullet image together with the X-ray image while superimposing the edges on the X-ray image, the method of displaying the gullet region together with the X-ray image while superimposing the gullet region on the X-ray image and blinking the gullet region, and the method of displaying the gullet region together with the X-ray image while superimposing the gullet region on the X-ray image and making the gullet region translucent.

The DICOM file conversion unit 40 converts the format of the data file of the X-ray image and of the data file of the gullet image into the DICOM format. The network interface unit 26 transmits the data file converted into the DICOM format to the X-ray computed tomography apparatus 100 or a PACS (Picture Archiving and Communication System) (not shown) via the LAN.

The image processing apparatus 20 further includes a curvature calculation unit 42 and a distance calculation unit 44 to further improve the accuracy and efficiency of ablation treatment.

The curvature calculation unit 42 calculates the curvature of the ablation catheter region or electrode catheter region. The calculated curvature data is supplied to the display control unit 34. The display control unit 34 compares the calculated curvature with a preset threshold. If the calculated curvature is larger than the threshold, the display control unit 34 superimposes and displays the gullet region on the X-ray image by the above display method.

The distance calculation unit 44 calculates the distance between the distal end portion of the ablation catheter region or electrode catheter region and the gullet region. The calculated distance data is supplied to the display control unit 34. The display control unit 34 compares the calculated distance with a preset threshold. If the calculated distance is larger than the threshold, the display control unit 34 superimposes and displays the gullet region on the X-ray image by the above display method. If the calculated distance is larger than the threshold, the display control unit 34 informs that the catheter is too near the gullet. In this manner, the display control unit 34 also functions as an informing unit.

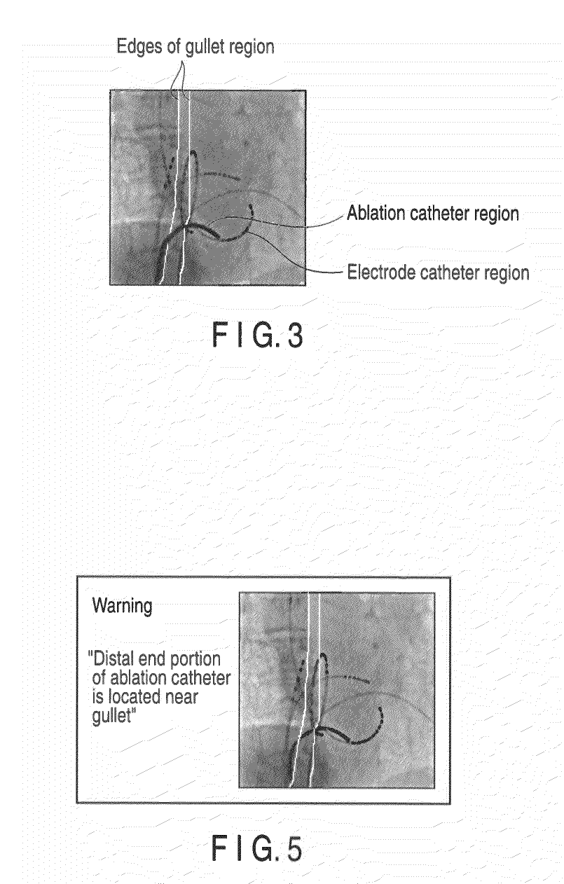

Display processing for a gullet image and an X-ray image by the display control unit 34 will be described in detail next. Note that in the following description, if it is not necessary to discriminate an ablation catheter from an electrode catheter, the ablation catheter and the electrode catheter will be collectively referred to as catheters. As described above, the display control unit 34 superimposes and displays a gullet region on an X-ray image by a predetermined display method selected via the operation unit 38 so as to allow visual recognition of the distal end portion of the catheter region. That is, the display control unit 34 displays only the edges of the gullet region, displays the gullet region while blinking it, or displays the gullet region while making it translucent. FIG. 3 is a view showing an example of how the gullet region and the X-ray image are displayed while only the edges of the gullet regions are superimposed on the X-ray image. As shown in FIG. 3, the X-ray image includes the regions of the ablation catheter and electrode catheter inserted in the left atrium. On the X-ray image, the edges of the gullet region are superimposed on the ablation catheter region and the electrode catheter region. Superimposing only the edges of the gullet region in this manner allows the operator to grasp the position and shape of the gullet on the X-ray image. That is, the operator can grasp the position of the distal end portion of the catheter region even when the catheter region is superimposed on the gullet region on the X-ray image.

When displaying the gullet region in a translucent state, the display control unit 34 displays the gullet region with a transparency that allows visual recognition of the pixel region on the X-ray image superimposed on the gullet region. When displaying the gullet region while blinking it, the display control unit 34 blinks the gullet region at, for example, every second.

Typical operation in ablation treatment support processing performed under the control of the system control unit 22 will be described next. FIG. 4 is a flowchart showing a typical procedure for support processing. Assume that gullet image data has already been generated at the start of support processing. Assume also that the X-ray image generation unit 24 repeatedly generates X-ray image data during support processing. Assume that the display method to be used for a gullet image and an X-ray image is the method of superimposing and displaying the edges of the gullet region on the X-ray image.

As shown FIG. 4, when X-ray image data is generated, the system control unit 22 causes the curvature calculation unit 42 to perform calculation processing (step S1). In step S1, the curvature calculation unit 42 extracts the ablation catheter region from the X-ray image based on the pixel value or shape of the ablation catheter region. The curvature calculation unit 42 calculates the curvature of the extracted ablation catheter region. The curvature changes in accordance with the pulsation of the heart as well as the degree of progress of the ablation catheter. Therefore, the curvature calculation unit 42 may calculate a curvature for each predetermined cardiac phase in synchronism with electrocardiogram data from an electrocardiograph (not shown). Calculating a curvature for each predetermined cardiac phase can suppress variations in curvature due to the pulsation of the heart.

Upon performing step S1, the system control unit 22 causes the display control unit 34 to perform determination processing (step S2). In step S2, the display control unit 34 determines whether the curvature of the ablation catheter region calculated in step S1 is larger than the first threshold. The ablation catheter is inserted into the left atrium during catheter operation. The distal end portion of the ablation catheter bends when it comes into contact with the inner wall of the left atrium. That is, when the distal end portion of the ablation catheter comes into contact with the inner wall, the curvature of the ablation catheter increases as compared when the distal end portion does not come into contact with the inner wall. When the first threshold is set to a proper value, that the curvature of the ablation catheter is larger than the first threshold is equivalent to that the ablation catheter is inserted in the left atrium. The operator can arbitrarily set the first threshold via the operation unit 38.

Upon determining in step S2 that the curvature is not larger than the first threshold (NO in step S2), the system control unit 22 returns to step S1. The system control unit 22 then repeats steps S1 and S2.

Upon determining that the ablation catheter has inserted into the left atrium, i.e., the ablation catheter region is larger than the first threshold (YES in step S2), the system control unit 22 causes the display control unit 34 to perform extraction processing (step S3). In step S3, the display control unit 34 extracts the edges of the gullet region from the gullet image generated in advance.

Upon performing step S3, the system control unit 22 causes the display control unit 34 to perform display processing (step S4). In step S4, the display control unit 34 superimposes and displays the extracted edges on the X-ray image. The display control unit 34 may display the curvature calculated in step S1. In this manner, the display control unit 34 displays the X-ray image and the gullet image in response to the insertion of the ablation catheter into the left atrium.

Upon performing step S4, the system control unit 22 causes the distance calculation unit 44 to perform calculation processing (step S5). In step S5, the distance calculation unit 44 specifies the distal end portion of the ablation catheter region on the X-ray image based on the pixel value or shape of the distal end portion of the ablation catheter region. The distance calculation unit 44 then calculates the distance between the specified distal end portion and the gullet region on the X-ray image. The calculated distance is, for example, the shortest distance between the distal end portion of the ablation catheter region and the gullet region. The calculated distance changes due to the pulsation of the heart as well as the degree of progress of the ablation catheter. Therefore, the distance calculation unit 44 calculates a distance for each predetermined cardiac phase in synchronism with electrocardiogram data from an electrocardiograph (not shown). Calculating a distance for each predetermined cardiac phase can suppress distance variations caused by the pulsation of the heart.

Upon performing step S5, the system control unit 22 causes the display control unit 34 to perform determination processing (step S6). In step S6, the display control unit 34 determines whether the distance calculated in step S5 is smaller than the second threshold. As described above, it is dangerous when the distal end portion of the ablation catheter is located near the gullet during catheter operation. Assume that the second threshold is set to a proper value. In this case, when the distance calculated in step S5 is smaller than the second threshold, there is a risk that the distal end portion of the ablation catheter is located near the gullet. The operator can arbitrarily set the second threshold via the operation unit 38.

Upon determining in step S6 that the distance is not smaller than the second threshold (NO in step S6), the system control unit 22 returns to step S5. The system control unit 22 then repeats steps S5 and S6.

Upon determining in step S6 that the distance is smaller than the second threshold (YES in step S6), the system control unit 22 causes the display control unit 34 to perform display processing (step S7). In step S7, the display control unit 34 issues a warning that the distal end portion of the ablation catheter is located near the gullet. A method of issuing a warning may be a method of displaying, for example, a warning message like that shown in FIG. 5, i.e., “the distal end portion of the ablation catheter is located near the gullet”, on the display device 36. In this case, the display control unit 34 may display the distance calculated in step S5 on the display device 36. The display control unit 34 may generate a warning sound from a loudspeaker (not shown). In this manner, when the ablation catheter approaches too much the gullet, the display control unit 34 generates a corresponding warning to the operator.

Upon performing step S7, the system control unit 22 terminates the ablation treatment support processing.

Note that the above support processing has been described in accordance with a typical procedure. That is, the support processing according to this embodiment is not limited to only the above procedure. For example, the display control unit 34 may display the edges of the gullet region when the distance between the distal end portion of the ablation catheter region and the gullet region is smaller than the second threshold.

If the distal end of the ablation catheter bends in the direction opposite to the X-ray tube 12, there is a risk that the distal end portion of the ablation catheter is located near the gullet. In step S7, the display control unit 34 may change the degree of warning of a warning message in accordance with the bending direction of the distal end portion. This processing will be described below. Assume that the X-ray irradiation direction is anterior-posterior direction (direction toward the back from the chest of the patient).

The display control unit 34 specifies the bending direction of the distal end portion of the ablation catheter in the real space based on the pixel value or shape of the distal end portion. Put more simply, the bending direction is defined based on whether the distal end portion of the ablation catheter bends in the back-and-forth direction for the X-ray tube 12 (the back-and-forth direction includes both of a direction to the X-ray tube 12 and a direction opposite to the X-ray tube 12). If, for example, the curvature of the ablation catheter is smaller than the first threshold, the display control unit 34 specifies that the distal end portion does not bend in the back-and-forth direction. In contrast, if the curvature of the ablation catheter is larger than the first threshold, the display control unit 34 specifies that the distal end portion bends in the back-and-forth direction. In this case, the display control unit 34 cannot specify whether the distal end portion bends to the X-ray tube 12 or opposite to the X-ray tube 12. In some cases, however, the operator of the ablation catheter can sensibly determine whether the distal end portion bends to the X-ray tube 12 or opposite to the X-ray tube 12. Knowing whether the distal end portion bends in the back-and-forth direction is useful for catheter operation in ablation treatment.

The display control unit 34 increases the degree of warning more when the distal end portion bends in the back-and-forth direction than when the distal end portion does not bend. In this manner, the display control unit 34 improves the accuracy of ablation treatment support by increasing the degree of warning when the bending direction is the back-and-froth direction.

The X-ray diagnosis apparatus 1 may be an X-ray diagnosis apparatus which performs a biplane imaging method. In this case, the X-ray image generation unit 24 generates the data of two X-ray images in two directions. The two directions include, for example, the anterior-posterior direction and a side direction (left to right or right to left). The two X-ray images in the two directions improve the accuracy of ablation catheter operation support.

For example, based on the two X-ray images in the two directions, the display control unit 34 specifies whether the distal end portion of the ablation catheter bends to an X-ray tube for X-ray imaging according to the anterior-posterior direction or opposite to the X-ray tube for X-ray imaging according to the anterior-posterior direction (whether the distal end portion bends in direction from front to rear of the X-ray image or from rear to front of the X-ray image). In other words, the display control unit 34 can specify whether the distal end portion of the ablation catheter bends toward the gullet or bends in the direction to separate from the gullet. More specifically, first of all, the display control unit 34 specifies the bending direction of the distal end portion of the ablation catheter region on the X-ray image in the anterior-posterior direction. Likewise, the display control unit 34 specifies the bending direction of the distal end portion of the ablation catheter region on the X-ray image in the side direction. If the bending direction in the anterior-posterior direction is the back-and-forth direction, and the bending direction in the side direction is the direction to X-ray tube for X-ray imaging according to the anterior-posterior direction, the display control unit 34 specifies that the distal end portion of the ablation catheter bends toward the gullet in the real space. The display control unit 34 then issues a warning that the distal end of the ablation catheter is too near the gullet. A method of issuing a warning may be a method of displaying, for example, the warning message “the distal end portion of the ablation catheter is too near the gullet” on the display device 36.

In the case of the X-ray diagnosis apparatus 1 configured to perform the biplane imaging method, the accuracy of positioning between an X-ray image and a gullet region improves. With this improvement, the accuracy of the distance between the distal end portion of the ablation catheter region and the gullet also improves.

As described above, the X-ray diagnosis apparatus 1 according to this embodiment implements a characteristic display method for gullet images and X-ray images. This characteristic display method is a method of superimposing and displaying a gullet region on an X-ray image while superimposing only the edges of the gullet region, or blinking the gullet region, or making the gullet region translucent. This allows the operator to grasp the positional relationship between the distal end portion of the ablation catheter and the gullet even when the ablation catheter is superimposed on the gullet on the X-ray image. In addition, this eliminates the necessity to change the imaging angle of the arm to grasp the position of the ablation catheter, thereby reducing the time and labor for the operation. That is, according to this embodiment, it is possible to provide an X-ray diagnosis apparatus and an image processing method associated with the X-ray diagnosis apparatus which improve the accuracy and efficiency of ablation treatment.

Note that the X-ray computed tomography apparatus 100 is configured to transmit volume data associated with a gullet region to the X-ray diagnosis apparatus 1. However, the X-ray computed tomography apparatus 100 need not be limited to this. The X-ray computed tomography apparatus 100 may transmit the data of a gullet image. In this case, the three-dimensional image processing unit 32 is not required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An X-ray diagnosis apparatus comprising:
an X-ray tube which generates X-rays;
an X-ray detector which detects X-rays generated by the X-ray tube and transmitted through a subject;
a storage unit which stores data of a gullet image associated with a gullet of the subject;
a generation unit which generates data of an X-ray image based on an output from the X-ray detector during catheter operation, the X-ray image being associated with a left atrium located anatomically near the gullet; and
a display unit which displays a gullet region of the gullet image together with the X-ray image while superimposing the gullet region on the X-ray image to allow visual recognition of a distal end portion of a catheter region included in the X-ray image.

2. The apparatus according to claim 1, wherein the display unit displays the edges of the gullet region together with the X-ray image while superimposing the edges on the X-ray image, displays the gullet region together with the X-ray image while superimposing the gullet region on the X-ray image and blinking the gullet region, and displays the gullet region together with the X-ray image while superimposing the gullet region on the X-ray image and making the gullet region translucent.

3. The apparatus according to claim 1, which further comprises a curvature calculation unit which calculates a curvature of the catheter region, and in which
the display unit displays the gullet region together with the X-ray image while superimposing the gullet region on the X-ray image to allow visual recognition of the distal end portion when the calculated curvature exceeds a first threshold.

4. The apparatus according to claim 1, further comprising
a distance calculation unit which calculates a distance between the distal end portion and a specific portion of the gullet region, and
an informing unit which informs that the distance has exceeded a second threshold, when the calculated distance has exceeded the second threshold.

5. The apparatus according to claim 4, wherein the display unit displays the calculated distance.

6. The apparatus according to claim 1, further comprising
a specifying unit which specifies a bending direction of the distal end of the catheter in a real space based on one of a pixel value of the distal end portion and a shape of the distal end portion, and
an informing unit which informs an operator of information corresponding to the bending direction.

7. An image processing method associated with an X-ray diagnosis apparatus comprising an X-ray tube which generates X-rays, and an X-ray detector which detects X-rays generated by the X-ray tube and transmitted through a subject, the method comprising:
generating data of an X-ray image based on an output from the X-ray detector during catheter operation, the X-ray image being associated with a left atrium located anatomically near the gullet; and
displaying a gullet region of the gullet image together with the X-ray image while superimposing the gullet region on the X-ray image to allow visual recognition of a distal end portion of a catheter region included in the X-ray image.
